(19) United States
(12) Patent Application Publication
(10) Pub. No.: US 2026/0019715 A1
(43) Pub. Date: Jan. 15, 2026

(54) VIDEO RECORDING CONTROL DEVICE AND VIDEO RECORDING METHOD

(71) Applicant: JVCKENWOOD Corporation, Yokohama-shi (JP)

(72) Inventor: Shinichi Miyamoto, Yokohama-shi (JP)

(21) Appl. No.: 19/333,436

(22) Filed: Sep. 19, 2025

Related U.S. Application Data
(63) Continuation of application No. PCT/JP2024/004020, filed on Feb. 7, 2024.

(30) Foreign Application Priority Data
Mar. 28, 2023 (JP) 2023-051967
Sep. 11, 2024 (JP) 2024-554143

(51) Int. Cl. H04N 23/74; G06T 5/50; G06T 7/11; G06V 10/60; H04N 23/71

(52) U.S. Cl. CPC H04N 23/74; G06T 5/50; G06T 7/11; G06V 10/60; H04N 23/71; G06T 2207/20221

(57) ABSTRACT

A video recording control device includes an imaging data obtaining unit that obtains imaging data; a luminance calculating unit that divides the imaging data into regions and calculates luminance for each divided region; a light source region setting unit that sets, as light source regions, the regions for which the luminance calculated by the luminance calculating unit is equal to or higher than a luminance threshold value; a luminance adjusting unit that adjusts the luminance of the light source regions either to the average value of luminance of other regions excluding the light source regions or to a predetermined value, and obtains post-adjustment data; and a recording control unit that records, in a recording unit, the imaging data along with the post-adjustment data having the luminance adjusted by the luminance adjusting unit.

### CROSS-REFERENCE TO RELATED APPLICATIONS

This application is a Continuation of PCT International Application No. PCT/JP2024/004020 filed on Feb. 7, 2024 which claims the benefit of priority from Japanese Patent Application No. 2023-051967, filed on Mar. 28, 2023 and Japanese Patent Application No. 2024-554143, filed on Sep. 11, 2024, the entire contents of all of which are incorporated herein by reference.

### BACKGROUND OF THE INVENTION

### 1. Field of the Invention

The present invention relates to a video recording control device and a video recording method.

### 2. Description of the Related Art

A technology has been disclosed that, at the time of the morning sun or the evening sun when the entire road changes color or due to the illumination of the neon lights installed inside a tunnel, when the entire road gets covered by the region in which the color feature quantities become similar, enables determination of the colors of boundary lines (for example, refer to Japanese Patent Application Laid-open No. 2010-044472).

For example, regarding an imaging device such as, what is called, a dashboard camera, a technology is known for expanding the dynamic range for brightness such as the wide dynamic range (WDR) or the high dynamic range (HDR). However, at nighttime when it is extremely dark overall, unless the dynamic range is further expanded, identification of bright objects as well as dark objects becomes a difficult task.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A video recording control device according to the present disclosure comprising: an imaging data obtaining unit that obtains imaging data; a luminance calculating unit that divides the imaging data into regions and calculates luminance for each divided region; a light source region setting unit that sets, as a light source region, a region for which luminance calculated by the luminance calculating unit is equal to or higher than a luminance threshold value; a luminance adjusting unit that adjusts luminance of the light source region either to average value of luminance of other regions excluding the light source region or to a predetermined value, and obtains post-adjustment data; and a recording control unit that records, in a recording unit, the imaging data along with the post-adjustment data having luminance adjusted by the luminance adjusting unit.

A video recording method according to the present disclosure comprising: obtaining imaging data; calculating that includes dividing the imaging data into regions and calculating luminance for each divided region; setting, as a light source region, a region for which luminance calculated at the calculating is equal to or higher than a luminance threshold value; adjusting that includes adjusting luminance of the light source region either to average value of luminance of other regions excluding the light source region or to a predetermined value, and obtaining post-adjustment data; and recording, in a recording unit, the imaging data along with the post-adjustment data having luminance adjusted at the adjusting.

### BRIEF DESCRIPTION OF THE DRAWINGS

FIG. 1 is a block diagram illustrating an example of a video recording device according to an embodiment;

FIG. 2 is a diagram illustrating an example of a pre-adjustment video;

FIG. 3 is a diagram illustrating an example of post-adjustment data;

FIG. 4 is a diagram illustrating another example of the post-adjustment data;

FIG. 5 is a diagram illustrating another example of the post-adjustment data; and

FIG. 6 is a flowchart for explaining an example of the operations performed in a control device according to the embodiment.

### DETAILED DESCRIPTION OF THE PREFERRED EMBODIMENTS

An exemplary embodiment of a video recording control device and a video recording method according to the application concerned is described below in detail with reference to the accompanying drawings. However, the present invention is not limited by the embodiment described below.

### EMBODIMENT

### Video Recording Device

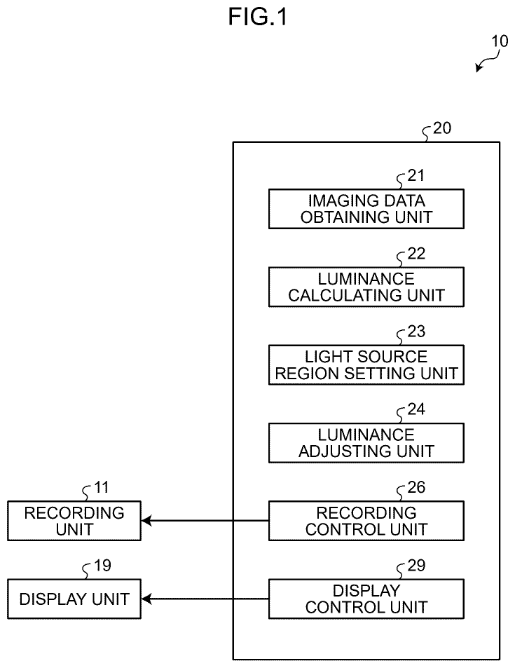

FIG. 1 is a block diagram illustrating an example of a video recording device according to the embodiment. When the imaging data contains high-luminance regions, the video recording device 10 performs luminance adjustment and records appropriate data. In the present embodiment, the video recording device 10 is implemented as, for example, one of the functions of an imaging device such as a dashboard camera.

The video recording device 10 includes a recording unit 11, a display unit 19, and a video recording control device (hereinafter, called a “control device”) 20.

The recording unit 11 is used for temporary storage of data in the video recording device 10. Examples of the recording unit 11 include a semiconductor memory device such as a random access memory (RAM) or a flash memory, and a recording unit such as a memory card. Alternatively, the recording unit 11 can be an external recording unit that is connected in a wireless manner via a communication device (not illustrated). In the recording unit 11, based on a control signal received from a recording control unit 26 of a control device 20, imaging data is recorded along with post-adjustment data that is obtained as a result of performing luminance adjustment.

The display unit 19 is, for example, a display device dedicated for the video recording device 10, or a display device shared with other systems and including a navigation system. Examples of the display unit 19 include a liquid crystal display or an organic electro-luminescence (EL) display. The display unit 19 displays videos based on video signals output from a display control unit 29 of the control device 20.

### Video Recording Control Device

The control device 20 is an arithmetic processing device (a control device) such as a central processing unit (CPU). The control device 20 loads a stored computer program into a memory, and executes the commands written in the computer program. The control device 20 includes an internal memory (not illustrated) that is used for temporary storage of data in the control device 20. The control device 20 includes an imaging data obtaining unit 21, a luminance calculating unit 22, a light source region setting unit 23, a luminance adjusting unit 24, the recording control unit 26, and the display control unit 29.

The imaging data obtaining unit 21 obtains imaging data that is generated as a result of imaging performed by a camera (not illustrated). Then, the imaging data obtaining unit 21 outputs the obtained imaging data to the luminance calculating unit 22.

The luminance calculating unit 22 divides the imaging data into regions, and calculates the luminance for each divided region. For example, the luminance calculating unit 22 divides the imaging data into latticed regions in units of blocks of few square pixels, and calculates the luminance for each divided region. For example, when the imaging is performed at nighttime, regarding the regions in which light sources such as traffic lights, white headlights of other vehicles, or orange blinkers are captured, the luminance calculating unit 22 calculates high luminance. On the other hand, for example, when the imaging is performed at nighttime, regarding the regions in which light sources such as traffic lights, white headlights of other vehicles, or orange blinkers are not captured, the luminance calculating unit 22 calculates low luminance.

Meanwhile, the luminance calculating unit 22 can divide the imaging data into latticed regions and can calculate the luminance regarding only those divided regions which are included within a predetermine range. That is because, for example, the regions in which traffic lights, white headlights of other vehicles, or orange blinkers are captured from a dashboard camera, which is an in-vehicle device, mostly remain fixed.

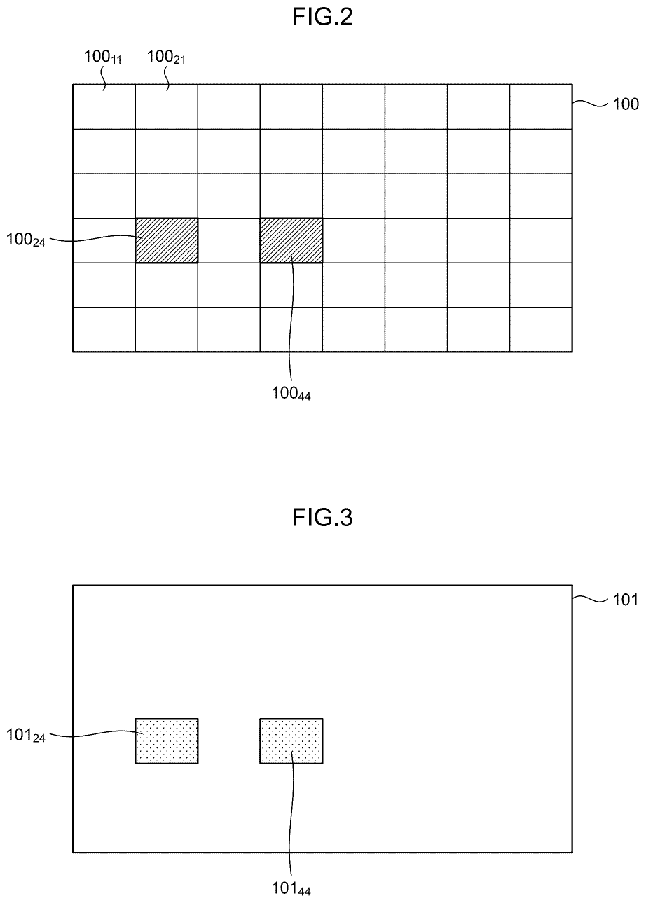

FIG. 2 is a diagram illustrating an example of a pre-adjustment video. In the example illustrated in FIG. 2, a video 100 is divided according to a lattice pattern into a plurality of regions 10011, 10012, and so on in units of blocks of few square pixels. The luminance calculating unit 22 calculates the luminance of each of those regions.

The light source region setting unit 23 sets, as light source regions, the regions in which the luminance calculated by the luminance calculating unit 22 is equal to or higher than a luminance threshold value. The luminance threshold value is approximately set to a value that leads to, what is called, overexposure in an image. For example, when the imaging is performed at nighttime, the luminance threshold value is approximately set to the luminance of the regions in which traffic lights, white headlights of other vehicles, or orange blinkers are captured.

In the example illustrated in FIG. 2, regions 100₂₄ and 100₄₄ are set as the light source regions.

The luminance adjusting unit 24 adjusts the luminance of the light source regions in the imaging data, which are set by the light source region setting unit 23, either to the average luminance of the other regions excluding the light source regions or to a predetermined value; and obtains post-adjustment data. More particularly, the luminance adjusting unit 24 adjusts the luminance of each pixel of the light source regions in such a way that the average luminance of the light source regions in the imaging data either approaches the average luminance of the other regions excluding the light source regions or approaches a predetermined value; and obtains post-adjustment data. The luminance adjusting unit 24 corrects the luminance of the units of blocks of few square pixels representing the light source regions in the imaging data by lowering the luminance either to the average luminance of the other regions excluding the light source regions or to a predetermined value. For example, even when white headlights of other vehicles or orange blinkers are captured in the light source regions, the luminance adjusting unit 24 becomes able to identify the colors without resulting in the overexposure of the light sources.

The recording control unit 26 records the imaging data obtained by the imaging data obtaining unit 21. In the present embodiment, when luminance adjustment is performed, the recording control unit 26 records the imaging data and the post-adjustment data in a corresponding manner in the recording unit 11. However, when luminance adjustment is not performed, the recording control unit 26 records only the imaging data in the recording unit 11.

Regarding the post-adjustment data, for example, the luminance of the light source regions can either be adjusted to the average value of the luminance of the other regions excluding the light source regions or be adjusted to a predetermined value, and then the data of only the light source regions in the imaging data can be treated as the post-adjustment data. In that case, the recording control unit 26 records, in the recording unit 11, the imaging data along with the post-adjustment data that, after the luminance of the light source regions is either adjusted to the average value of the luminance of the other regions excluding the light source regions or adjusted to a predetermined value, represents the data of only the light source regions in the imaging data. Such post-adjustment data is called first-type adjustment data.

FIG. 3 is a diagram illustrating an example of the post-adjustment data. In FIG. 3 is illustrated the first-type adjustment data. In FIG. 3, a video 101 includes only the post-adjustment light source regions having the adjusted luminance. Thus, luminance adjustment is performed only for regions 101₂₄ and 101₄₄ that represent the light source regions.

For example, the post-adjustment data is obtained when the light source regions in the imaging data are substituted with the light source regions in the first-type adjustment data. In other words, the post-adjustment data is obtained when the units of blocks of few square pixels equivalent to the light source regions in the first-type adjustment data are clipped and superimposed on the units of blocks of few square pixels equivalent to the light source regions in the imaging data. In other words, for example, in the post-adjustment data, the luminance of the units of blocks of few square pixels, which are equivalent to the light source regions in the imaging data, can either be adjusted to the average value of the luminance of the other regions excluding the light source regions or be adjusted to a predetermined value; and the other regions can be kept unchanged from the imaging data. In that case, the recording control unit 26 records, in the recording unit 11, the imaging data along with the post-adjustment data in which the luminance of the units of blocks of few square pixels, which are equivalent to the light source regions of the imaging data, is either adjusted to the average value of the luminance of the other regions excluding the light source regions or adjusted to a predetermined value, and the other regions are kept unchanged from the imaging data. In other words, the recording control unit 26 records, in the recording unit 11, the imaging data along with the post-adjustment data obtained when the light source regions in the imaging data are substituted with the light source regions in the first-type adjustment data. Such post-adjustment data is called second-type adjustment data.

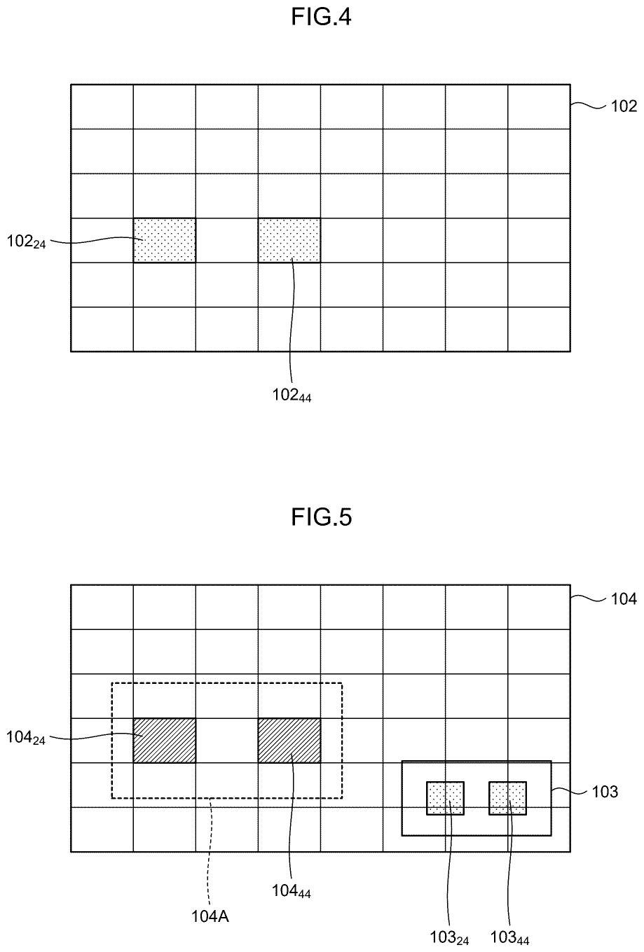

FIG. 4 is a diagram illustrating another example of the post-adjustment data. In FIG. 4 is illustrated the second-type adjustment data. In FIG. 4, the luminance of the light source regions is adjusted, and the other regions are kept unchanged from the imaging data. In a video 102, the luminance is adjusted for regions 102₂₄ and 102₄₄ representing the light source regions.

For example, the post-adjustment data is obtained when a region including the light source regions in the first-type adjustment data is clipped and superimposed on those regions in the imaging data in which predetermined objects are not recognized. In that case, firstly, the recording control unit 26 performs image processing with respect to the imaging data and detects the regions in which predetermined objects including other mobile objects such as other vehicles, or pedestrians, or traffic lights, or road signs are not recognized. Regarding the method for recognizing predetermined objects from the imaging data, any known method can be implemented without restriction. The recording control unit 26 records, in the recording unit 11, the imaging data along with the post-adjustment data that is obtained when a region including the light source regions in the first-type adjustment data is clipped and superimposed on those regions in the imaging data in which predetermined objects are not recognized. Such post-adjustment data is called third-type adjustment data.

FIG. 5 is a diagram illustrating another example of the post-adjustment data. In FIG. 5 is illustrated the third-type adjustment data. The data illustrated in FIG. 5 is obtained when a region including the light source regions in the first-type adjustment data is clipped and superimposed on those regions in the imaging data in which predetermined objects are not recognized. In a video 104, with respect to regions 104₂₄ and 104₄₄ representing the light source regions, a video 103 having adjusted luminance is superimposed in the bottom right portion. The video 103 is obtained by clipping, from the video 102 illustrated in FIG. 4, the range corresponding to a range 104A of the video 104 as illustrated using dashed lines. In the video 103, regions 103₂₄ and 103₄₄ representing the light source regions have their luminance adjusted in an identical manner to the regions 102₂₄ and 102₄₄. When a plurality of light source regions is present, they can be arranged, for example, from the bottom right in ascending order of distance from the concerned vehicle.

The display control unit 29 controls the display to be output in the display unit 19. The display control unit 29 outputs a video signal for causing the display unit 19 to output the imaging data or the post-adjustment data.

When the recording control unit 26 records the imaging data and the first-type adjustment data, the display control unit 29 can display the second-type adjustment data or the third-type adjustment data in the following manner. Firstly, the explanation is given about displaying the second-type adjustment data. The display control unit 29 outputs a video signal for causing the display unit 19 to output the second-type adjustment data in which the light source regions of the imaging data are substituted with the light source regions of the first-type adjustment data.

Given below is the explanation about displaying the third-type adjustment data. Firstly, the display control unit 29 performs image processing with respect to the imaging data, and detects the regions in which predetermined objects are not recognized. Then, the display control unit 29 outputs a video signal for causing the display unit 19 to output the third-type adjustment data in which a region including the light source regions in the first-type adjustment data is clipped and superimposed on those regions in the imaging data in which predetermined objects are not recognized.

### Operations Performed in Video Recording Control Device

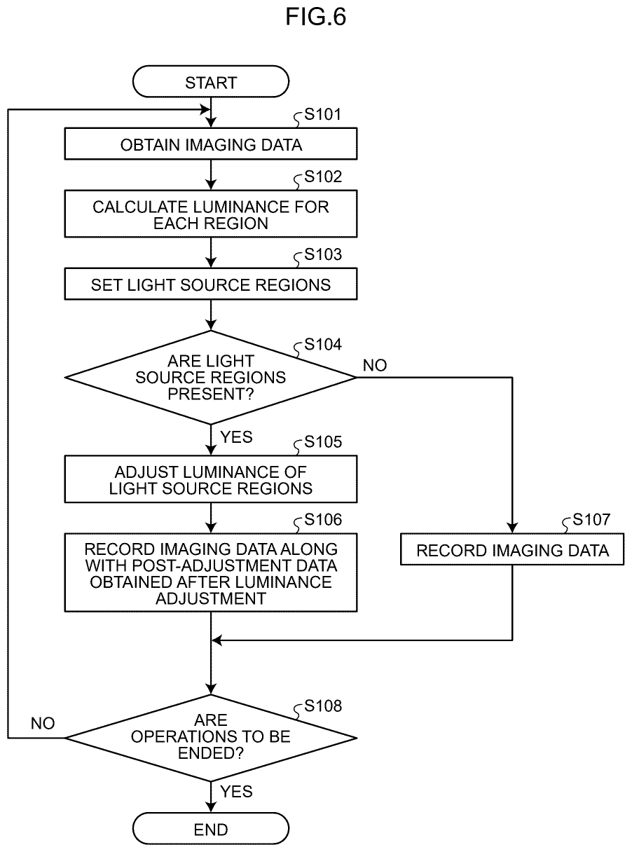

Explained below with reference to FIG. 6 is the flow of operations performed in the control device 20 according to the present embodiment. FIG. 6 is a flowchart for explaining an example of the operations performed in the control device according to the embodiment.

The imaging data obtaining unit 21 of the control device 20 obtains the imaging data obtained as a result of imaging performed by a camera (not illustrated) (Step S101). Then, the system control proceeds to Step S102.

The luminance calculating unit 22 of the control device 20 divides the imaging data into latticed regions and calculates the luminance of each divided region (Step S102). Then, the system control proceeds to Step S103.

The light source region setting unit 23 of the control device 20 sets the light source regions (Step S103). More specifically, the light source region setting unit 23 of the control device 20 sets, as the light source regions, the regions for which the luminance calculated by the luminance calculating unit 22 is equal to or higher than the luminance threshold value. Then, the system control proceeds to Step S104.

The control device 20 determines whether or not the light source regions are present (Step S104). More specifically, when the light source region setting unit 23 sets light source regions in the imaging data, the control device 20 determines that the light source regions are present. When it is determined that the light source regions are present (Yes at Step S104), the system control proceeds to Step S105. On the other hand, when it is not determined that the light source regions are present (No at Step S104), the system control proceeds to Step S107.

When it is determined that the light source regions are present (Yes at Step S104), the luminance adjusting unit 24 of the control device 20 adjusts the luminance of the light source regions (Step S105). More specifically, the luminance adjusting unit 24 of the control device 20 adjusts the luminance of the light source regions in the imaging data, which are set by the light source region setting unit 23, either to the average value of the luminance of the other regions excluding the light source regions or to a predetermined value. Then, the system control proceeds to Step S106.

The recording control unit 26 of the control device 20 records, in the recording unit 11, the imaging data along with the post-adjustment data obtained after performing luminance adjustment (Step S106). Then, the system control proceeds to Step S108.

When it is not determined that the light source regions are present (No at Step S104), the recording control unit 26 of the control device 20 records the imaging data in the recording unit 11 (Step S107). Then, the system control proceeds to Step S108.

The control device 20 determines whether or not to end the operations (Step S108). For example, when the power source or the driving force of the vehicle is switched OFF or when an end operation is performed with respect to the video recording device 10, it is determined to end the operations. When it is determined to end the operations (Yes at Step S108), the control device 20 ends the operations. When it is not determined to end the operations (No at Step S108), the control device 20 again performs the operations from Step S101 onward.

In this way, in the video recording device 10, when the imaging data contains light source regions in which light sources are captured, luminance adjustment is performed and the imaging data is recorded in a corresponding manner to the post-adjustment data.

### Effects

As explained above, in the present embodiment, in the recording unit 11, the imaging data is recorded along with the post-adjustment data obtained when the luminance of the light source regions in the imaging data is either adjusted to the average value of the luminance of the other regions excluding the light source regions or adjusted to a predetermined value. According to the present embodiment, using the imaging data, the colors in dark places can be made identifiable. According to the present embodiment, using the post-adjustment data, the light source regions such as traffic lights, white headlights of other vehicles, or orange blinkers can be corrected and the colors can be made identifiable. In the present embodiment, since the post-adjustment data gets recorded in a corresponding manner to the imaging data, it becomes possible to confirm the non-adjusted data too. According to the present embodiment, at nighttime when it is extremely dark overall, bright objects as well as dark objects can be made identifiable.

In the present embodiment, in the post-adjustment data, the light source regions in the imaging data are substituted with the luminance-adjusted light source regions in the post-adjustment data. According to the present embodiment, using the post-adjustment data, at nighttime when it is extremely dark overall, bright objects as well as dark objects can be made identifiable.

In the present embodiment, the post-adjustment data is obtained when a region including the luminance-adjusted light source regions in the post-adjustment data is clipped and superimposed on those regions in the imaging data in which predetermined objects are not recognized. According to the present embodiment, using the post-adjustment data, at nighttime when it is extremely dark overall, bright objects as well as dark objects can be made identifiable.

In the present embodiment, the imaging data is divided into latticed regions, and the luminance is calculated for each divided region. According to the present embodiment, the light source regions in which light sources are captured can be set in minute detail. According to the present embodiment, it becomes possible to appropriately set the light source regions in which the luminance is adjusted.

Till now, the embodiment of the application concerned was described. However, the present invention is not limited by the details given in the embodiment. Moreover, the constituent elements described above are not to be thus limited but are to be construed as embodying all modifications and alternative constructions that may occur to one skilled in the art that fairly fall within the basic teaching herein set forth.

### MODIFICATION EXAMPLE

The shape of the regions formed by division by the luminance calculating unit 22 is not limited to the lattice shape. Alternatively, for example, the luminance calculating unit 22 can divide the imaging data into striped regions having vertical stripes, horizontal stripes, or oblique stripes, and can calculate the luminance for each divided region. Alternatively, for example, the luminance calculating unit 22 can divide the imaging data into concentric regions from the center of the imaging data, and can calculate the luminance for each divided region.

The luminance calculating unit 22 can divide the imaging data into latticed regions and, from among the divided regions, can calculate the luminance for only those regions which are included within a predetermined range. Thus, according to the present embodiment, luminance calculation need not be performed for all regions, thereby enabling achieving work-saving.

According to the present embodiment, at nighttime when it is extremely dark overall, it becomes possible to identify bright objects as well as dark objects.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A video recording control device comprising:
an imaging data obtaining unit that obtains imaging data;
a luminance calculating unit that divides the imaging data into regions and calculates luminance for each divided region;
a light source region setting unit that sets, as a light source region, a region for which luminance calculated by the luminance calculating unit is equal to or higher than a luminance threshold value;
a luminance adjusting unit that adjusts luminance of the light source region either to average value of luminance of other regions excluding the light source region or to a predetermined value, and obtains post-adjustment data; and
a recording control unit that records, in a recording unit, the imaging data along with the post-adjustment data having luminance adjusted by the luminance adjusting unit.

2. The video recording control device according to claim 1, wherein, in the post-adjustment data, the light source region in the imaging data is substituted with a light source region in post-adjustment data having luminance adjusted by the luminance adjusting unit.

3. The video recording control device according to claim 1, wherein, the post-adjustment data is obtained when a region including a light source region in post-adjustment data, which has luminance adjusted by the luminance adjusting unit, is clipped and superimposed on a region in the imaging data in which a predetermined object is not recognized.

4. The video recording control device according to claim 1, wherein the luminance calculating unit divides the imaging data into latticed regions and calculates luminance for each divided region.

5. A video recording method comprising:
obtaining imaging data;
calculating that includes dividing the imaging data into regions and calculating luminance for each divided region;
setting, as a light source region, a region for which luminance calculated at the calculating is equal to or higher than a luminance threshold value;
adjusting that includes adjusting luminance of the light source region either to average value of luminance of other regions excluding the light source region or to a predetermined value, and obtaining post-adjustment data; and
recording, in a recording unit, the imaging data along with the post-adjustment data having luminance adjusted at the adjusting.
